(19) United States
(12) Patent Application Publication
(10) Pub. No.: US 2024/0295298 A1
(43) Pub. Date: Sep. 5, 2024

(54) SIMULATED ELECTRONIC CANDLE

(71) Applicant: DongGuan Shuiquanzi Industrial Co., Ltd., Dongguan City (CN)

(72) Inventor: Huilin SHE, Dongguan City (CN)

(21) Appl. No.: 18/184,147

(22) Filed: Mar. 15, 2023

(30) Foreign Application Priority Data
Mar. 1, 2023 (CN) 202320378433.5

(51) Int. Cl. F21S 10/04; F21V 3/02

(52) U.S. Cl. CPC F21S 10/043; F21V 3/02; F21Y 2115/10

(57) ABSTRACT

The utility model provides a simulated electronic candle, including an LED light, a candle flame-like light-transmitting lampshade, and a PCB configured to control the LED light. The light-transmitting lampshade has an axis hole with a through bottom, and the LED light includes a columnar lamp holder and a pin. The lamp holder includes an upper light-emitting section and a lower black cotton-like core section. The light-emitting section extends into the axis hole and is fixed with the light-transmitting lampshade, and the pin is welded to the PCB. The lamp holder is arranged as the light-emitting section and the cotton-like core section, and the pin is welded to the PCB, so as to form a single-piece structure. The simulated electronic candle has a simpler structure, reduces product costs, and does not need a plurality of operations such as welding and threading during assembly, obviously improving the production efficiency and quality stability.

### TECHNICAL FIELD

The utility model relates to the technical field of simulated electronic candles.

### BACKGROUND

A simulated electronic candle has the characteristics such as smokeless, strong safety, and long service life. With the increasing degree of simulation, the simulated electronic candle has been used to replace a conventional candle in many occasions. At present, the simulated electronic candle has a mature structure. A structure of a simulated electronic candle generally includes an LED light, a candle flame-like light-transmitting lampshade, a candle-like housing, and a PCB. The light-transmitting lampshade is fixed to the top of the housing, and the LED light is accommodated in the light-transmitting lampshade and driven by the PCB to emit light. In order to further improve the simulation effect, some simulated electronic candles are provided with simulated cotton cores to simulate a candle wick. For example, the Chinese Utility Model Patent with the patent No. CN213207691U discloses a high-simulation electronic candle. The structure thereof includes a wick conduit inserted in the top center of a simulated housing, a wire electrically connecting an illuminator to a circuit board and extending through the wick conduit, and a simulated burnt layer covering outside of the wick conduit to simulate the cotton core of the candle. In the process of assembly and production of this simulated electronic candle, a relatively long wire needs to be first welded to the illuminator, the wire is caused to extend through the wick conduit covered by the simulated burnt layer and then to extend through and be fixed to the simulated housing as a whole, then the other end of the wire is welded to the circuit board, the circuit board and the battery box are fixed inside the simulated housing, and finally the flame head is fixed to the top of the wick conduit. After the assembly, the burnt layer still needs to be adjusted to a proper position of the wick conduit. The simulation electronic candle with this structure not only has many parts and complicated structure, but also is assembled through a very troublesome process, and therefore the quality stability is easily affected by the proficiency of workers.

### SUMMARY

For the disadvantages of the existing electronic candle with a simulated wick, the utility model provides a simulated electronic candle that has a simpler structure, is easy to assemble, and has stable quality.

In order to achieve the above objective, the utility model adopts the technical solutions as follows.

A simulated electronic candle includes an LED light, a candle flame-like light-transmitting lampshade, and a PCB configured to control the LED light. The light-transmitting lampshade has an axis hole with a through bottom, the LED light includes a columnar lamp holder and a pin, the lamp holder includes an upper light-emitting section and a lower black cotton-like core section, the light-emitting section extends into the axis hole and is fixed with the light-transmitting lampshade, and the pin is welded to the PCB.

As a preferred solution, the light-transmitting lampshade is made of a silica gel material, and the light-emitting section is in interference fit with the axis hole.

As a preferred solution, an inner diameter of a section of the axis hole fitted with the light-emitting section is greater than that of the upper light-emitting section, so that a limiting step is formed in the axis hole.

As a preferred solution, the simulated electronic candle further includes a candle-like housing. The housing has a side wall and a top surface, an accommodating cavity with an open bottom is formed therein, and a center of the top surface is provided with a through hole configured for the LED light to extend through.

As a preferred solution, a bottom of the cotton-like core section is further provided with a limiting boss with a relatively large diameter, and an inner wall of the top surface is provided with a limiting groove matching the limiting boss.

As a preferred solution, a bottom of the accommodating cavity is further provided with a battery box, and the PCB is vertically fixed above the battery box in the accommodating cavity.

The utility model has the beneficial effects as follows. The lamp holder of the LED light is arranged as the light-emitting section and the cotton-like core section, and the pin is directly welded to the PCB, so as to form a single-piece structure. Compared with the existing electronic candle with a simulated cotton core, the simulated electronic candle not only has a simpler structure and fewer parts, which reduces product costs, but also can be assembled through a very simple assembly process without a plurality of operations such as welding and threading, which obviously improves the production efficiency and quality stability.

### BRIEF DESCRIPTION OF THE DRAWINGS

The utility model is further described in detail below with reference to the accompanying drawings and specific embodiments.

FIG. 1 is a three-dimensional view of a whole structure of a simulated electronic candle according to an embodiment.

FIG. 2 is a schematic diagram of an internal structure of a simulated electronic candle according to an embodiment.

FIG. 3 is a three-dimensional view of a light-transmitting lampshade according to an embodiment.

FIG. 4 is a schematic diagram of an internal structure of a housing according to an embodiment.

### DETAILED DESCRIPTION

The utility model is further described below with reference to the accompanying drawings.

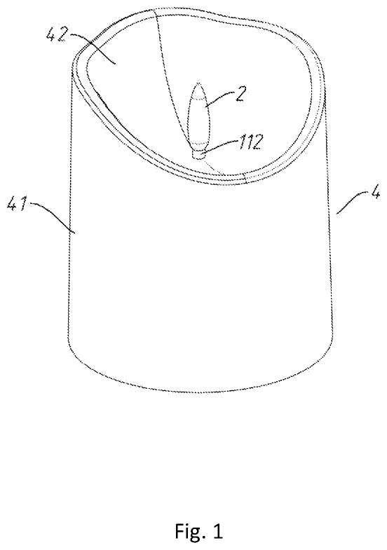

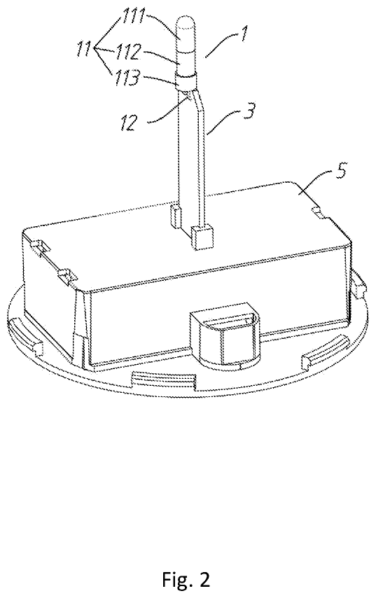

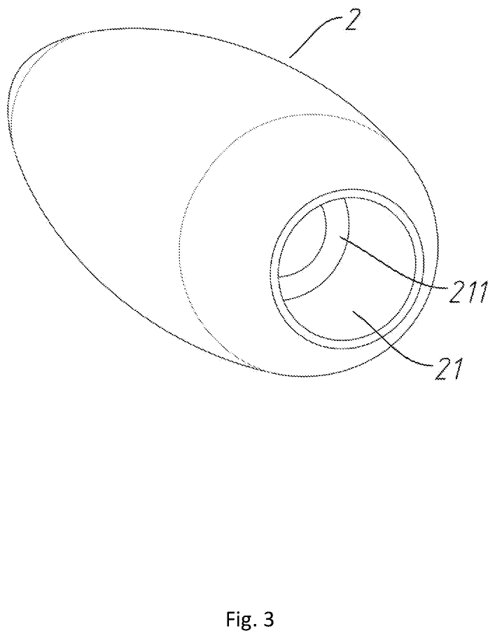

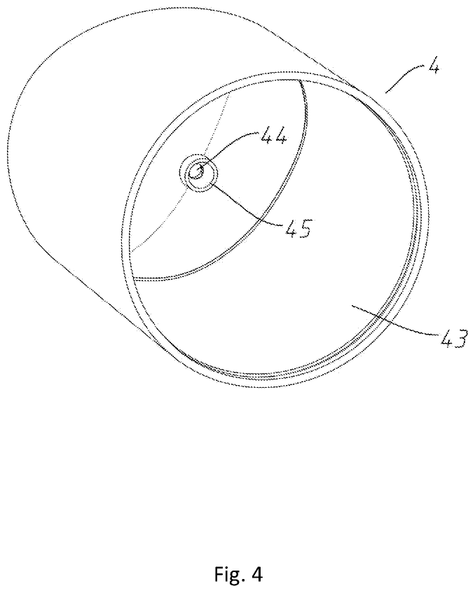

Referring to FIG. 1 to FIG. 4, this embodiment uses a simulated electronic candle as an example for description. The simulated electronic candle includes an LED light 1, a candle flame-like light-transmitting lampshade 2, a PCB 3 configured to control the LED light 1, a candle-like housing 4, and a battery box 5. The housing 4 has a side wall 41 and a top surface 42, an accommodating cavity 43 with an open bottom is formed therein, and a center of the top surface 42 is provided with a through hole 44 configured for the LED light 1 to extend through. The light-transmitting lampshade 2 has an axis hole 21 with a through bottom, the LED light 1 includes a columnar lamp holder 11 and a pin 12, and the lamp holder 11 includes an upper light-emitting section 111 and a lower black cotton-like core section 112. The light-emitting section 111 extends into the axis hole 21 and is fixed with the light-transmitting lampshade 2. The battery box 5 is fixed to the bottom of the accommodating cavity 43, the PCB 3 is vertically fixed above the battery box 5 in the accommodating cavity 43, and the pin 12 is welded to the top of the PCB 3.

During assembly, only the PCB 3 welded with the LED light 1 needs to be fixed to the battery box 5, and then is inserted upward from the bottom of the housing 4 as a whole, so as to fix the battery box 5 and the housing 4. In addition, the lamp holder 11 of the LED light 1 extends through the through hole 44 of the housing 4, and finally the light-transmitting lampshade 2 is fixed to the lamp holder 11 of the LED light 1. The lamp holder 11 of the LED light 1 is arranged as the light-emitting section 111 and the cotton-like core section 112, and the pin 12 is directly welded to the PCB, so as to form a single-piece structure. Compared with the existing electronic candle with a simulated cotton core, the simulated electronic candle not only has a simpler structure and fewer parts, which reduces product costs, but also can be assembled through a very simple assembly process without a plurality of operations such as welding and threading, which obviously improves the production efficiency and quality stability.

The housing 4 may be in the shape of a large candle with a large diameter and a small height, or may be in the shape of a stick candle with a small diameter and a large length. When the housing 4 is in the shape of a large candle, the battery box 5 may be arranged transversely, and the PCB 3 may be fixed to the top surface 42 of the battery box 5. When the housing 4 is in the shape of a stick candle, the battery box 5 may be integrally formed at the lower section of the housing 4 in series, and the PCB 3 may be directly fixed to the upper section of the housing 4.

In an implementation structure, the light-transmitting lampshade 2 is made of a silica gel material, and the light-emitting section 111 is in interference fit with the axis hole 21. The interference fit between the light-transmitting lampshade 2 and the light-emitting section 111 makes the assembly simple and convenient, and it is convenient for consumers to replace lampshades with different shapes or colors. In addition, the light-transmitting lampshade 2 is flexible and has a safer tip.

In an implementation structure, an inner diameter of a section of the axis hole 21 fitted with the light-emitting section 111 is greater than that of the upper light-emitting section, so that the axis hole 21 forms a limiting step 211. On the one hand, the limiting step 211 can facilitate the positioning during the mounting, and prevent the light-emitting section 111 from being inserted too deeply into the light-transmitting lampshade 2 to block the cotton-like core section 112 and even affect the shading effect of the light-transmitting lampshade 2. On the other hand, the light-emitting section 111 abuts against the plane of the limit step 211, so that a better shading effect is achieved through transmission near the position.

In an implementation structure, a bottom of the cotton-like core section 112 is further provided with a limiting boss 113 with a relatively large diameter, and an inner wall of the top surface 42 is provided with a limiting groove 45 matching the limiting boss 113. The limiting boss 113 is matched and limited by the limiting groove 45, which not only achieves more stable mounting of the LED light 1, but also accurately limits the position of the LED light 1 when being inserted upward, thereby preventing the cotton-like core section 112 from extending into the housing 4 by an excessively short or excessively long distance.

The above descriptions do not constitute a limitation on the technical scope of the utility model. Any modification, equivalent change, and modification of the above embodiments according to the technical essence of the utility model still fall within the scope of the technical solution of the utility model.

What is claimed is:

1. A simulated electronic candle, comprising an LED light, a candle flame-like light-transmitting lampshade, and a PCB configured to control the LED light, wherein the light-transmitting lampshade has an axis hole with a through bottom, the LED light comprises a columnar lamp holder and a pin, the lamp holder comprises an upper light-emitting section and a lower black cotton-like core section, the light-emitting section extends into the axis hole and is fixed with the light-transmitting lampshade, and the pin is directly welded to the PCB, so as to form a single-piece structure;
an inner diameter of a section of the axis hole fitted with the light-emitting section is greater than that of the upper light-emitting section, so that a limiting step is formed in the axis hole; and
the candle flame-like light-transmitting lampshade is integrally formed as a whole.

2. The simulated electronic candle according to claim 1, wherein the light-transmitting lampshade is made of a silica gel material, and the light-emitting section is in interference fit with the axis hole.

3. (canceled)

4. The simulated electronic candle according to claim 1, further comprising a candle-like housing, wherein the housing has a side wall and a top surface, an accommodating cavity with an open bottom is formed therein, and a center of the top surface is provided with a through hole configured for the LED light to extend through.

5. The simulated electronic candle according to claim 4, wherein a bottom of the cotton-like core section is further provided with a limiting boss with a relatively large diameter, and an inner wall of the top surface is provided with a limiting groove matching the limiting boss.

6. The simulated electronic candle according to claim 4, wherein a bottom of the accommodating cavity is further provided with a battery box, and the PCB is vertically fixed above the battery box in the accommodating cavity.
